(19) United States
(12) Patent Application Publication
(10) Pub. No.: US 2007/0228146 A1
(43) Pub. Date: Oct. 4, 2007

(54) Managing Medical-Related Financial Data

(76) Inventors: Lisa H. Rogers, Palo Alto, CA (US); Edward D. Robinson, St. Paul, MN (US); Hector S. Lopez, Sausalito, CA (US); Terry F. LeClair, Fremont, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/277,671

(22) Filed: Mar. 28, 2006

(51) Int. Cl. G07F 19/00; G06Q 10/00

(52) U.S. Cl. 235/379; 705/2

(57) ABSTRACT

A clearinghouse receives medical-related financial data, including data describing payment claims for medical services from a provider and payment polices and explanations of benefits (EOBs) from a payer. The clearinghouse aggregates the data into logical units, such as family units. A translation module translates codes in the EOBs or other data into layperson descriptions. An end-user uses a client computer to download the aggregated medical-related financial data from the clearinghouse. An analytics module at the client computer analyzes the medical-related financial data to identify items of interest to the end-user, such as billing and payment errors, and available tax deductions. The end-user can input personal medical data and the analytics module will correlate the medical data with the medical services identified by the financial data.

### BACKGROUND

This invention pertains in general to managing medical-related financial data using a computer.

Managing medical insurance payments is a difficult and time consuming process. When a person becomes seriously ill, has a baby, or encounters another life experience that requires substantial interaction with a medical provider, that person can expect to receive significant amounts of related paperwork. The paperwork includes, for example, financial forms, such as invoices, from the medical providers and explanations of benefits (EOBs) from payers like insurance companies and government agencies.

Medical invoices and EOBs can be quite complex. EOBs in particular contain large amounts of information, such as descriptions of the procedures performed, the amounts the payer paid, the amounts that the patient owes, the reasons that the claims were denied, etc. Further, there is no standard format for an EOB, and each payer typically uses a different format.

The complexities of invoices and EOBs present difficulties for a person who wants to track the information contained therein. The medical billing procedure is complicated and the providers and payers often make mistakes. For example, a payer can pay an insufficient amount for a claim or a provider can improperly code a claim to a payer. These mistakes can have a financial impact on the person who sought treatment.

In order to catch mistakes, the person must review the invoices from the providers and decipher and correlate the EOBs from the payers. Computer software programs are available to help people manage invoices and EOBs. However these programs still require people to decipher the invoices and EOBs and input the data into the programs. Thus, even with these programs there is still a risk of a data entry mistake. Moreover, the programs do not perform complex analyses of the financial data in order to catch billing mistakes and similar errors.

### SUMMARY

A clearinghouse receives medical-related financial data and then electronically distributes it to client computers. The clearinghouse receives data describing claims for payment from medical services providers. Similarly, the clearinghouse receives data describing payment polices and explanations of benefits (EOBs) from payers, such as insurance companies.

The clearinghouse processes the received medical-related financial data by, for example, aggregated the data into logical units, such as family units. Processing can also include grouping data from related events. Further, the clearinghouse can process the data by translating codes in the data into layperson descriptions of medical services.

An end-user uses the client computer to download the medical-related financial data from the clearinghouse. An analytics module at the client computer analyzes the medical-related financial data to identify items of interest to the end-user, such as billing and payment errors, and available tax deductions. The end-user can input personal medical data and the analytics module will correlate the medical data with the medical services identified by the financial data. Since the end-user does not manually enter the medical-related financial data, the chore of entering the data is removed and the quality of the data is improved.

### BRIEF DESCRIPTION OF THE DRAWINGS

FIG. 1 is a high-level block diagram illustrating an environment for managing medical-related financial data according to one embodiment.

FIG. 2 is a high-level block diagram of an embodiment of a computer that can be utilized by the provider, payer, clearinghouse, client, and/or other entity in the environment of FIG. 1.

FIG. 3 is a high-level block diagram illustrating a more detailed view of the clearinghouse according to one embodiment.

FIG. 4 is a high-level block diagram illustrating the client and modules within the medical financial data management module according to one embodiment.

FIG. 5 is a flow chart illustrating steps performed by the clearinghouse according to one embodiment.

FIG. 6 is a flow chart illustrating steps performed by the client according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE EMBODIMENTS

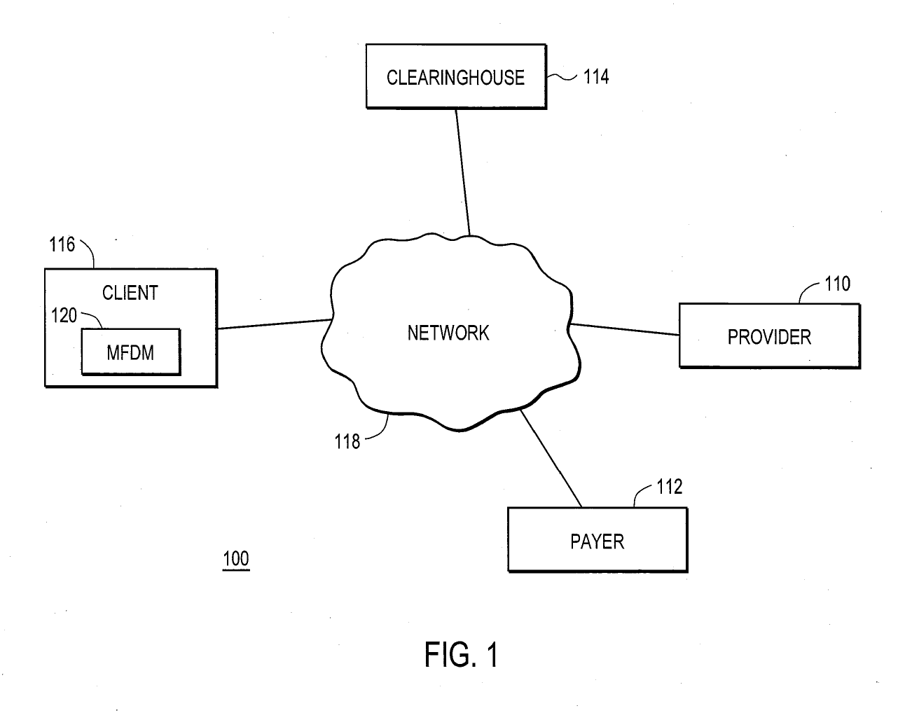

FIG. 1 is a high-level block diagram illustrating an environment 100 for managing medical-related financial data according to one embodiment. The environment includes a healthcare provider 110 and a healthcare payer 112, a clearinghouse 114, and a client 116. A network 118 couples these entities. FIG. 1 illustrates only one provider 110, payer 112, and client 116 for purposes of clarity. Real-world embodiments of the environment 100 can have hundreds or thousands of these entities. Likewise, some embodiments have multiple clearinghouses 114 and/or networks 118.

The provider 110 represents an entity that provides healthcare, e.g., by performing medical services or providing medical products to a patient. For example, the provider 110 can be a doctor's office, clinic, therapist, hospital, pharmacy and/or outsourced billing department for one of these providers. The provider 110 treats a patient by conducting a consultation or providing medicine or medical equipment such as crutches. Upon providing the treatment, the provider 110 sends a claim for payment to the patient and/or the payer 112. In one embodiment, the provider 110 sends a description of the claim to the clearinghouse 114. In addition, an embodiment of the provider 110 also sends medical findings (e.g., test results) the clearinghouse 114.

The payer 112 represents an entity that pays medical claims. For example, the payer 112 can be an employer, insurer, and/or government agency. The payer 112 typically has contracts (i.e., policies) with patients that describes the terms under which the payer will pay medical expenses incurred by the patients. In addition, the payer 112 often has contracts with the providers 110 describing the amounts that the payer 112 will pay for the medical services.

In one embodiment, the payer 110 receives claims for payment from the provider 112. In response, the payer 112 calculates the payments owed to the provider 110 under the terms of the payer's policies with the patient and/or provider. The payer 112 provides the payer with a payment in fulfillment of the claim, and an explanation of benefits (EOB) that describes how it derived the amount of the payment. In addition, the payer 112 provides the clearinghouse 114 with the EOB. In one embodiment, the payer 112 provides the clearinghouse with additional data, such as the terms of the policies with the patients, as described in more detail below.

The clearinghouse 114 is an entity that receives medical-related financial data from the provider 110, payer 112, client 116, and/or other entities. The clearinghouse 114 processes the data and provides the data to the client 116. In one embodiment, the processing performed by the clearinghouse 114 converts the data received from the provider 110 and/or payer 112 into a format that can be utilized by the client 116 to perform accounting on the medical-related financial data. In some embodiments, the clearinghouse 114 performs additional processing on the financial data, such as reviewing the data for errors.

The client 116 is utilized by an end-user to receive medical-related financial data from the clearinghouse 114. The end-user can be, for example, the patient that sought treatment from the provider, the head-of-household for the patient (e.g., the parent of a minor patient), and/or an accountant or other person authorized to review the medical-related financial data for the patient. In one embodiment, the client executes a medical financial data management (MFDM) module 120 that provides functionality for organizing the financial data and/or analyzing it for billing and payment errors, tax deductions, and other possible items of interest to the end-user.

The network 118 provides data communications between and among the other entities illustrated in FIG. 1. In one embodiment, the network 118 uses standard communications technologies and/or protocols. In another embodiment, the network 118 uses custom data communications technologies and/or protocols.

As will be understood by those of skill in the art, the provider 110, payer 112, clearinghouse 114, and client 116 in the environment 100 of FIG. 1 utilize computer systems that are connected to the network 118. For example, in one embodiment the client 116 is a personal computer operated by the end-user. Similarly, the payer 112 utilizes a computer that is adapted to automatically receive claims from providers 110, generate EOBs, and provide the EOBs and/or financial funds transfers to the provider 110 and/or clearinghouse 114.

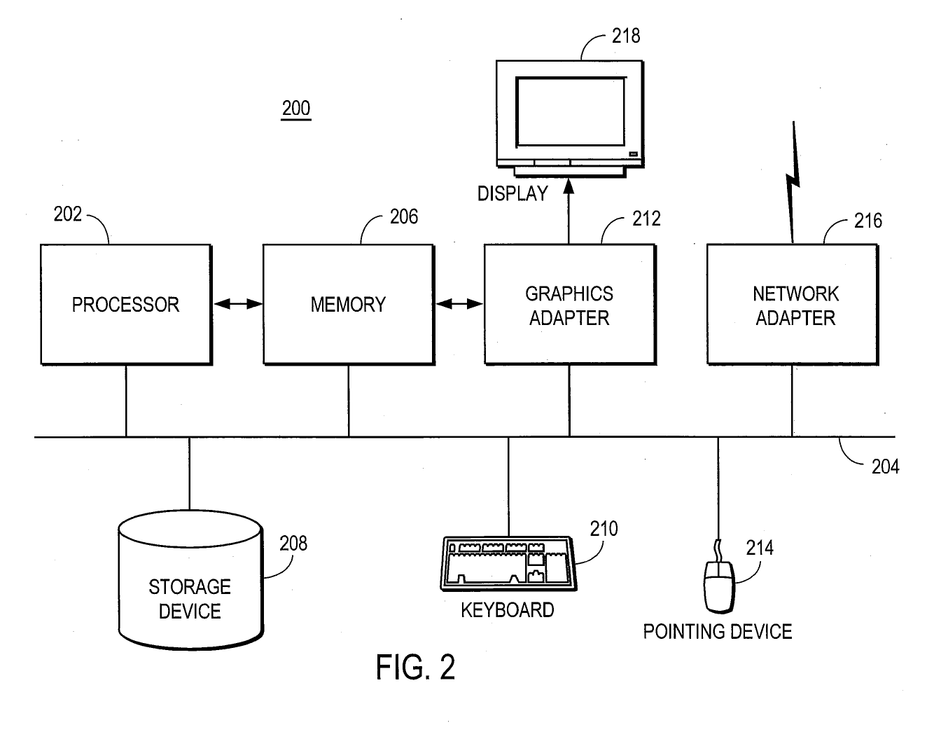

FIG. 2 is a high-level block diagram of an embodiment of a computer that can be utilized by the provider 110, payer 112, clearinghouse 114, client 116, and/or other entity in the environment of FIG. 1. Illustrated are at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212. In some embodiments, one or more of the components of the computer 200 may be located remotely and accessed via the network 118. Computers acting in different roles may have different and/or additional elements than the ones shown in FIG. 2. For example, a computer 200 acting as a clearinghouse 114 may have greater processing power and a larger storage device than a computer acting as a client 116. Likewise, a computer 200 acting as a clearinghouse 114 may lack devices such as a display 218 and/or keyboard 210 that are not necessarily required to operate it.

As is known in the art, the computer 200 is adapted to execute computer program modules. As used herein, the term “module” refers to computer program logic for providing the specified functionality. A module can be implemented in hardware, firmware, and/or software. When utilized, the modules are usually loaded into the memory 206 and executed by the processor 202.

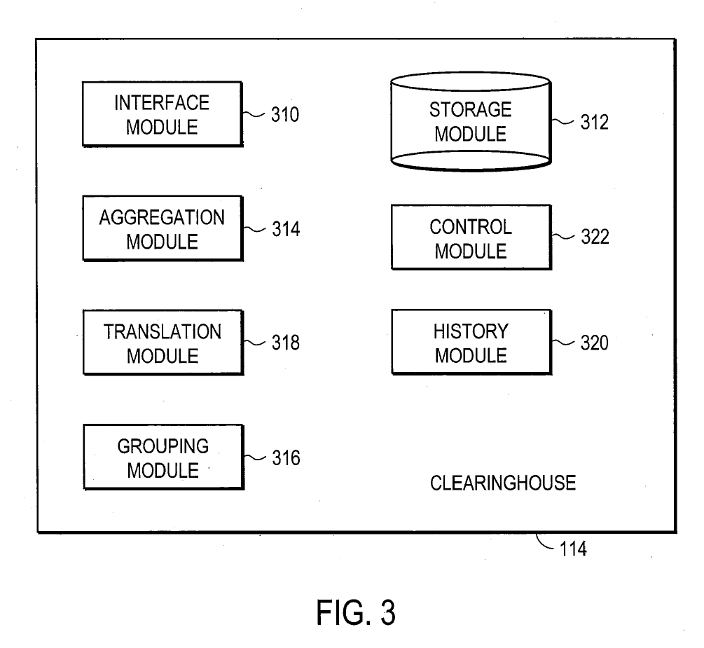

FIG. 3 is a high-level block diagram illustrating a more detailed view of the clearinghouse 114 according to one embodiment. Other embodiments can have different and/or additional modules than those shown in FIG. 3. Likewise, the functionalities can be distributed among the modules in a manner different than described herein.

An interface module 310 supports the exchange of data with other entities connected to the network 118. To this end, the interface module 310 receives data from the provider 110 describing treatments provided, payment claims made, and/or medical findings. Likewise, the interface module 310 receives data from the payer 112 including descriptions of payment policies (e.g., insurance policies) and the EOBs. The payment policies describe rules that the payer 112 utilizes to make claims payments, such as the terms of an insurance policy. These terms can describe, for example, deductions, out-of-pocket maximums, co-pay amounts, the people who are covered by the policies, and limitations on coverage. The clearinghouse 114, client 116, and/or another entity can utilize the payment policies to verify the information contained in EOBs and identify billing errors. The interface module 310 receives requests for medical-related financial data from the client 116, and provides the financial data in response. Alternatively, the interface module 310 occasionally pushes medical-related financial data to the client 116.

A clearinghouse storage module 312 stores data received from the provider 110 and/or payer 112 for access by other modules in the clearinghouse 114. The storage module 312 utilizes a relational database and/or another data store adapted to enable efficient storage and retrieval of information. In one embodiment, the stored data is encrypted to prevent unauthorized access.

An aggregation module 314 aggregates information received from the provider 110 and/or payer 112 into logical units. Typically, the data that the clearinghouse 114 receives from the provider 110 and payer 112 are keyed to the specific patient for whom medical care was provided. The aggregation module 314 aggregates the data into logical groups such as family units, employees of a single employer, etc. For example, assume that the end-user of the client 116 is a parent or other family member responsible for managing the family's medical bills. The clearinghouse 114 receives separate EOBs and other data for each family member, such as the end-user, the end-user's spouse, and their children. The aggregation module 314 aggregates the separate data into logical units using patient identifiers such as names, social security numbers, payment policy numbers, etc.

A grouping module 316 aggregates related medical procedure data and/or EOBs. For example, a patient's single visit to a healthcare provider can result in multiple invoices and/or EOBs for different services and/or goods provided during the visit. The grouping module 316 detects data from the provider 110 and/or payer 112 associated with a single visit or other point of reference and groups such data. In one embodiment, the grouping module 316 uses information such as the dates on which services where performed, the identity of the patient, they types of services performed, and/or other data provided by the provider 110 and/or payer 112 to perform the grouping.

A translation module 318 translates codes and other referencing information in data received from the provider 110 and/or the EOBs received from the payer 112 into layperson descriptions. Oftentimes, an EOB will contain numeric and textual codes that describe a specific procedure with which the EOB is associated. However, a layperson who observes the codes typically cannot interpret them. In one embodiment, the translation module 318 includes a dictionary that contains layperson descriptions of all or some of the codes that are contained in the EOBs. The translation module 318 analyzes the codes using the dictionary to obtain the corresponding layperson descriptions.

A history module 320 tracks data that has been provided to a client 116. In one embodiment, this tracking is utilized to give the end-user of the client 116 the option of downloading only data that is new since the end-user last contacted the clearinghouse 114. In addition, the history module 320 provides the ability to repeat past downloads.

A control module 322 controls the operation of the clearinghouse 114. To this end, the control module 322 causes the various other modules in the clearinghouse 114 to perform functions such as downloading data from the provider 110 and/or payer 112, aggregating and/or grouping the data, and providing the data to a client 116.

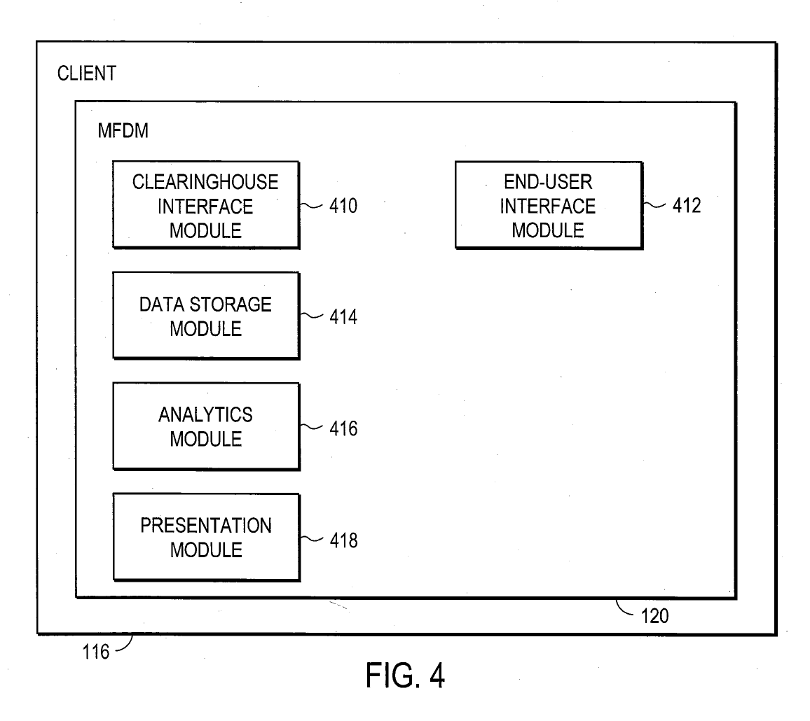

FIG. 4 is a high-level block diagram illustrating the client 116 and modules within the MFDM 120 according to one embodiment. Other embodiments can have different and/or additional modules than those shown in FIG. 4. Likewise, the functionalities can be distributed among the modules in a manner different than described herein.

A clearinghouse interface module 410 of the MFDM 120 interacts with the clearinghouse 114 via the network 118 to download medical-related financial data such as descriptions of payment policies and/or EOBs. In addition, in one embodiment the clearinghouse interface module 410 also downloads medical data, such as findings, from the clearinghouse 114. In one embodiment, the downloaded data is organized into logical units and/or groups. For example, the downloaded data can contain all of the data for the end-user's family. The data downloading can be initiated by the client 116 and/or by the clearinghouse 114.

An end-user interface module 412 interacts with, and accepts inputs from, the end-user of the client 116. Through the end-user interface module 412, the end-user can cause the MFDM 120 to download medical-related financial data from the clearinghouse 114 and/or perform other tasks. In one embodiment, the end-user uses the end-user interface module 412 to provide personal medical data to the MFDM 120. The personal medical data can include, for example, a description of exercise and eating habits, cholesterol levels, allergies, weight, moods, etc. In other embodiment, some or all of this medical information is provided to the clearinghouse 114 by the provider 110, and then downloaded from the clearinghouse to the client 116.

A data storage module 414 stores the medical-related financial data and/or other types of data downloaded from the clearinghouse 114. In addition, the data storage module 414 also stores personal medical data and other types of data input by the end-user. Some or all of the data can be encrypted to prevent unauthorized access.

An analytics module 416 performs analyses of the data stored in the data storage module 414 in order to identify billing and payment errors, tax deductions, and other possible items of interest to the end-user. In an alternative embodiment, the analytics module 416 is located within the clearinghouse 114 and the clearinghouse interface module 410 downloads the output of the analytics module for use at the client 116. In another embodiment, the functionality of the analytics module 416 is distributed among the MFDM 120 at the client 116, the clearinghouse 114, and/or another entity.

The analytics module 416 processes the downloaded data in ways that provide insight to the end-user. To this end, the analytics module 416 cross-references descriptions of medical services received from the providers 110 with corresponding EOBs. This analysis is used to identify services performed, payments made in exchange for those services, fees that remain to be paid, etc. In addition, the analysis identifies billing-related errors such as duplicate billings or payments, and delays in payment. Further, the analytics module 416 compares the EOBs with the payment policy to determine whether the payer 112 has paid the amounts it is supposed to pay according to the policy.

In one embodiment, the analytics module 416 also performs analyses related to personal finance. For example, the analytics module 416 can identify the total amounts spent by the end-user and/or the end-user's unit on healthcare. This information can be used to identify available tax deductions, manage spending for a flexible healthcare spending account, etc. In addition, an embodiment of the analytics module 416 transforms the data into formats adapted for use with other financial management software packages, such as QUICKEN and/or TURBOTAX, both available from Intuit, Inc. of Mountain View, Calif.

In one embodiment, the analytics module 416 enables the end-user to generate a personal medical history. The MFDM 120 obtains medical data about the end-user through direct input and/or download from the clearinghouse 114. The analytics module 416 generates reports correlating the information in meaningful ways. For example, the end-user can provide data describing exercise and eating habits over time. Likewise, the MFDM 120 can download reports describing the end-user's cholesterol levels over the same time period. The analytics module 416 analyzes the end-user's habits in view of the cholesterol levels, and generates a report identifying correlations between these two data points. In another example, the analytics module 416 generates a report correlating other data, such as descriptions of the end-user's mental states with visits to therapists. The analytics module 416 can identify and date the therapist visits by analyzing the EOBs received from the clearinghouse 414.

A presentation module 418 presents the results of reports generated by the analytics module 416 and/or other modules to the end-user. In one embodiment, the presentation module 418 generates graphs and other types of graphical displays that illustrate the reports. For example, the presentation module 418 can generate a graph that illustrates medical expenses by month, that counts the billing errors made by a provider 110 in a given time period, that shows mood swings relative to therapist visits, or that represents deductions found by the analytics module 416 as a percentage of total medical expenses. The presentation module 418 can also present textual representations of the analysis, such as messages describing an available income tax deduction or layperson descriptions of the medical procedures identified in the EOBs.

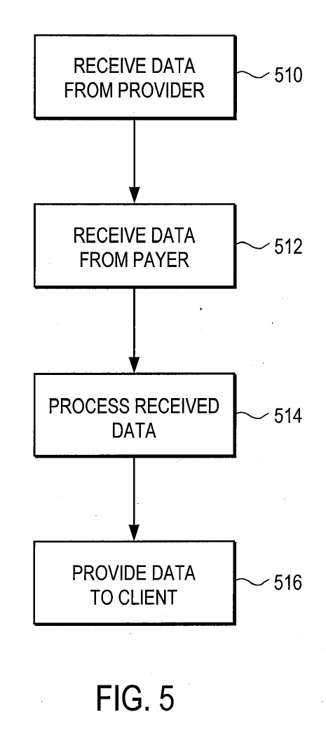

FIG. 5 is a flow chart illustrating steps performed by the clearinghouse 114 according to one embodiment. Other embodiments can perform additional and/or different steps than the ones shown in FIG. 5. In addition, other embodiments can perform the steps in different orders. In one embodiment, the modules of the clearinghouse 114 perform these steps under the guidance of the control module 320. In other embodiments, some or all of the steps are performed by other modules and/or other entities shown in the environment 100 of FIG. 1.

The clearinghouse 114 receives 510 data from the provider 110. The data can describe treatments provided, payment claims made, and/or medical findings with respect to one or more patients. Likewise, the clearinghouse 114 receives 512 data from the payer 112 including descriptions of payment policies (e.g., insurance policies) and the EOBs.

The clearinghouse 114 processes 514 the received data into a format adapted for transmission to a client 116. This processing 514 can include steps as aggregating the data into logical units, grouping data describing related medical procedures, and translating obscure codes in the EOBs into layperson descriptions.

At some point, the clearinghouse 114 receives a request from the client 116 for medical-related financial data and/or other types of data stored by the clearinghouse. The requested data can be related to a particular end-user and/or an aggregation, such as a family, associated with the end-user. In response, the clearinghouse 114 determines which medical-related financial data has not yet been provided to the client 116, and sends the data to the client. Alternatively, the clearinghouse 114 can push the data to the client 116 at predetermined and/or regular intervals. Aggregated data are sent as a single download.

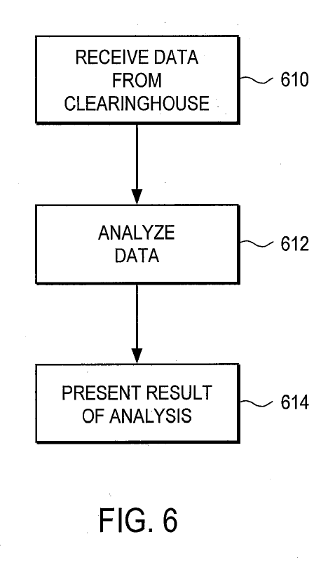

FIG. 6 is a flow chart illustrating steps performed by the client 116 according to one embodiment. Other embodiments can perform additional and/or different steps than the ones shown in FIG. 6. In addition, other embodiments can perform the steps in different orders. In one embodiment, the modules of the MFDM 120 perform these steps. In other embodiments, some or all of the steps are performed by other modules and/or other entities shown in the environment 100 of FIG. 1.

The client 116 receives 610 the medical-related financial data and/or other data from the clearinghouse 114. The client 116 analyzes 612 the data to identify aspects such as the total amounts spent by the end-user and/or the end-user's unit on healthcare, available tax deductions, spending in a flexible healthcare spending account, etc. The client 116 can further analyze the data in view of medical information provided by the end-user and/or downloaded from the clearinghouse 114 to generate a personal medical history for the end-user. The client 116 presents 614 the results of the analysis by, for example, generating graphical or textual representations of the medical-related financial data.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

We claim:

1. A system for delivering medical-related financial data to a client computer utilized by an end-user, comprising:
a storage module adapted to store medical-related financial data received from an external computer;
an aggregation module for aggregating the stored medical-related financial data into logical units; and
an interface module adapted to receive the medical-related financial data from the external computer and to provide the aggregated medical-related financial data to the client computer utilized by the end-user.

2. The system of claim 1, wherein the interface module is further adapted to interface with a provider computer to receive a description of a claim for medical services for a patient.

3. The system of claim 1, wherein the interface module is further adapted to interface with a payer computer to receive an explanation of benefits (EOB) describing a payment for medical services.

4. The system of claim 1, wherein the interface module is further adapted to interface with a payer computer to receive a payment policy describing rules that the payer utilizes to make payments in response to claims for medical services made by medical service providers.

5. The system of claim 1, wherein the aggregation module is adapted to aggregate medical-related financial data pertaining to a family.

6. The system of claim 1, further comprising:
a translation module adapted to translate codes in the medical-related financial data received from the external computer into layperson descriptions of medical procedures represented by the codes.

7. A method for delivering medical-related financial data, comprising:
receiving medical-related financial data from an external computer;
aggregating the received medical-related financial data into logical units; and
providing the aggregated medical-related financial data to a client computer utilized by an end-user.

8. The method of claim 7, wherein the receiving comprises:
interfacing with a provider computer to receive a description of a claim for medical services for a patient.

9. The method of claim 7, wherein the receiving comprises:
interfacing with a payer computer to receive an explanation of benefits (EOB) describing a payment for medical services.

10. The method of claim 7, wherein the receiving comprises:
interfacing with a payer computer to receive a payment policy describing rules that the payer utilizes to make payments in response to claims for medical services made by medical service providers.

11. The method of claim 7, wherein aggregating comprises:
aggregating medical-related financial data pertaining to a family.

12. The method of claim 7, further comprising:
translating codes in the medical-related financial data received from the external computer into layperson descriptions of medical procedures represented by the codes.

13. A computer program product having a computer-readable medium having computer program instructions recorded thereon for obtaining medical-related financial data via a network, comprising:
a storage module adapted to store medical-related financial data and a description of a payment policy received via the network;
an analytics module adapted to analyze the medical-related financial data and the payment policy to identify items of interest to an end-user of a computer system; and
a presentation module adapted to present the identified items of interest to the end-user.

14. The computer program product of claim 13, wherein the analytics module is adapted to identify billing and/or payment errors evidenced by the medical-related financial data and/or payment policy.

15. The computer program product of claim 13, wherein the analytics module is adapted to identify tax deductions evidenced by the medical-related financial data and/or payment policy.

16. The computer program product of claim 13, further comprising:
an end-user interface module adapted to receive personal medical data from the end-user;
wherein the analytics module is adapted to correlate the personal medical data with the medical-related financial data and wherein the presentation module is adapted to present the correlation to the end-user.

17. The computer program product of claim 13, further comprising:
a clearinghouse interface module adapted to communicate with a clearinghouse computer via the network to receive the medical-related financial data and the description of the payment policy.

18. The computer program product of claim 17, wherein the clearinghouse interface module is further adapted to receive layperson descriptions of medical procedures represented by codes in the medical-related financial data.

19. A system for delivering medical-related financial data, comprising:
a provider computer utilized by a healthcare provider, the healthcare provider generating medical-related financial data, the provider computer adapted to interface with a medical data clearinghouse, the clearinghouse comprising:
a storage module adapted to store medical-related financial data received from one or more provider computers;
an aggregation module for aggregating the stored medical-related financial data into logical units; and
an interface module adapted to receive the medical-related financial data from the one or more provider computers.

20. The system of claim 19, wherein the medical-related financial data generated by the provider computer comprise a description of a claim for medical services for a patient.

21. The system of claim 19, wherein the interface module is further adapted to interface with a payer computer to receive an explanation of benefits (EOB) describing a payment for medical services.

22. The system of claim 19, wherein the interface module is further adapted to interface with a payer computer to receive a payment policy describing rules that the payer utilizes to make payments in response to claims for medical services made by the healthcare provider.

23. The system of claim 19, wherein the aggregation module is adapted to aggregate medical-related financial data pertaining to a family.

24. The system of claim 19, further comprising:
a translation module adapted to translate codes in the medical-related financial data received from the provider computer into layperson descriptions of medical procedures represented by the codes.

25. The system of claim 19, wherein the interface module is further adapted to provide the aggregated medical-related financial data to a client computer utilized by an end-user.

26. A system for receiving medical-related financial data, comprising:
a client computer utilized by an end-user, the client computer adapted to interface with a medical data clearinghouse, the clearinghouse comprising:
a storage module adapted to store medical-related financial data received from one or more provider computers;
an aggregation module for aggregating the stored medical-related financial data into logical units; and
an interface module adapted to receive the medical-related financial data from the one or more provider computers and to provide the aggregated medical-related financial data to the client computer.

27. The system of claim 26, wherein the medical-related financial data generated by a provider computer comprise a description of a claim for medical services for a patient.

28. The system of claim 26, wherein the interface module is further adapted to interface with a payer computer to receive an explanation of benefits (EOB) describing a payment for medical services.

29. The system of claim 26, wherein the interface module is further adapted to interface with a payer computer to receive a payment policy describing rules that the payer utilizes to make payments in response to claims for medical services received from a provider computer.

30. The system of claim 26, wherein the aggregation module is adapted to aggregate medical-related financial data pertaining to a family.

31. The system of claim 26, further comprising:
a translation module adapted to translate codes in the medical-related financial data received from the provider computer into layperson descriptions of medical procedures represented by the codes.

32. An apparatus for delivering medical-related financial data to a client computer utilized by an end-user, comprising:
storage means for storing medical-related financial data received from an external computer;
aggregation means for aggregating the stored medical-related financial data into logical units; and
interface means for receiving the medical-related financial data from the external computer and providing the aggregated medical-related financial data to the client computer utilized by the end-user.

33. The apparatus of claim 32, wherein the interface means are further for interfacing with a provider computer to receive a description of a claim for medical services for a patient.

34. The apparatus of claim 32, wherein the interface means are further for interfacing with a payer computer to receive an explanation of benefits (EOB) describing a payment for medical services.

35. The apparatus of claim 32, wherein the interface means are further for interfacing with a payer computer to receive a payment policy describing rules that the payer utilizes to make payments in response to claims for medical services made by medical service providers.

36. The apparatus of claim 32, wherein the aggregation means are further for aggregating medical-related financial data pertaining to a family.

37. The apparatus of claim 32, further comprising:
translation means for translating codes in the medical-related financial data received from the external computer into layperson descriptions of medical procedures represented by the codes.
